(19) United States
(12) Patent Application Publication
(10) Pub. No.: US 2012/0013058 A1
(43) Pub. Date: Jan. 19, 2012

(54) GRAVITY COMPENSATOR OF MOTOR

(76) Inventor: Hyeung sik Choi, Busan (KR)

(21) Appl. No.: 13/258,762

(22) PCT Filed: Mar. 31, 2010
(86) PCT No.: PCT/KR10/01954

§ 371 Date: Sep. 22, 2011

(30) Foreign Application Priority Data
Mar. 31, 2009 (KR) 10-2009-0027365

(51) Int. Cl. H02K 7/14; F16F 1/14

(52) U.S. Cl. 267/154

(57) ABSTRACT

The present invention relates to a gravity compensator of a motor for naturally compensating load moment according to a rotation angle of a load, wherein the load moment results from the gravity torque in accordance with the rotational angle. The gravity compensator comprises: a supporting frame; a rotational shaft which is prepared to allow the rotation thereof in relation to the supporting frame; a load which is fixed to the rotational shaft and is rotated together with the rotational shaft; a driving motor which provides a rotational force to the rotational shaft to drive the rotation of the rotational shaft; and a torsion bar which has one end thereof coupled to the rotational shaft to form a rotating end that rotates together with the rotational shaft and includes the other end thereof coupled to the supporting frame to form a fixed end that does not rotate with the rotational shaft. Gravity compensation can be performed with an even simpler structure compared to the prior art, and thus the invention can be applied to a very small-sized motor.

### TECHNICAL FIELD

The present invention relates to a gravity compensator of a motor, intended to compensate for a gravity load caused by gravity torque depending on a rotating angle of a load, which acts on a rotating shaft rotating along with the load as a driving motor is driven.

### BACKGROUND ART

Generally, a load, such as a link, connected to a driving shaft of a driving motor of a robot or an automatic machine increases the load torque (hereinafter referred to as ‘gravity torque’) due to the influence of gravity depending on a rotating angle of the load.

That is, when an actuating arm, a leg of a walking robot or a robot arm rotates up and down, moment increases due to gravity as the rotating angle increases. Thereby, a load moment is created in the driving motor and this increases in proportion to the rotating angle. Thus, the general driving motor must output a rotating force that is resistant to the load moment including the gravity torque.

Meanwhile, since the driving torque and the rotation velocity of the driving shaft output from the driving motor are inversely proportion to each other, a reduction gear may be used to reduce the rotation velocity and increase the driving torque. Here, the larger the reduction gear ratio is, the more complicated and larger the reduction gear tends to be.

As such, in order to output the rotating force resistant to the load moment including the gravity torque, the driving motor may be provided with the reduction gear. However, in the case of using the reduction gear, the size of the motor must inevitably be increased to maintain the velocity of rotation constant.

Meanwhile, Korean Patent No. 10-0801799 has been proposed by the inventor of this invention, which is entitled “Gravity Compensator of Motor”. This compensator includes a rotary plate coupled to a rotating shaft of a motor to rotate along with the rotating shaft, and a stationary plate supported independently from the rotary movement of the motor. A plurality of slots is formed in a predetermined portion of the stationary or rotary plate, and springs are inserted into the respective slots. Further, the rotary or stationary plate having no slot includes elastic plates to support the springs. Thereby, this compensator compensates the gravity torque of a load depending on a rotating angle using the compressive or tensile elastic force of the springs.

Such a conventional compensator is an improvement in the technology because it can compensate for gravity without changing the size of the motor or using a reduction gear. However, this compensator is problematic in that the stationary plate and the rotary plate must be mounted around the rotating shaft of the driving motor, so that the entire structure of the compensator is relatively complicated, and besides a size of the compensator is large.

This does not cause a large problem in the case of a general driving motor. However, a small-sized driving motor requires a simpler configuration, while a large-sized driving motor requires a more excellent gravity compensating ability.

Further, the conventional compensator is problematic in that unidirectional gravity compensation is relatively simply achieved, but bidirectional gravity compensation requires a more complicated structure.

### DISCLOSURE

### Technical Problem

Accordingly, the present invention has been made keeping in mind the above problems occurring in the prior art, and an object of the present invention is to provide a gravity compensator of a motor, intended to naturally compensate for load moment according to a rotating angle, wherein the load moment results from gravity torque depending on a rotating angle of a load.

Another object of the present invention is to provide a gravity compensator of a motor, intended to compensate for gravity using a simpler structure as compared to the prior art, thus being applicable to various sizes of motors.

### Technical Solution

In order to accomplish the above objects, the present invention provides a gravity compensator of a motor, including a supporting frame; a rotating shaft rotatably provided on the supporting frame; a load secured to the rotating shaft to be rotated along with the rotating shaft; a driving motor supplying a rotating force to the rotating shaft to rotate the rotating shaft; and a torsion bar connected at a first end thereof to the rotating shaft to form a rotary end that rotates along with the rotating shaft, and connected at a second end thereof to the supporting frame to form a fixed end that cannot be rotated along with the rotating shaft.

Preferably, the fixed end of the torsion bar may be coupled to the supporting frame in such a way as to slide in a longitudinal direction of the torsion bar.

Preferably, the gravity compensator may further include an elastic member for elastically supporting the fixed end of the torsion bar in the longitudinal direction of the torsion bar.

Preferably, the torsion bar and a driving shaft of the motor may be perpendicular to the rotating shaft, and the torsion bar may be placed to be parallel to the driving shaft of the motor, and the rotary end of the torsion bar and the rotating shaft may be coupled to each other by bevel gear coupling.

### Advantageous Effects

As apparent from the above description, the present invention provides a gravity compensator of a motor, intended to naturally compensate for the load moment using an elastic force of a torsion bar, wherein the load moment results from gravity torque depending on a rotating angle of a load.

Particularly, the present invention provides a gravity compensator of a motor, intended to compensate for gravity using a simpler structure as compared to the prior art, thus being applicable to a large-sized motor as well as a very small-sized motor.

### DESCRIPTION OF DRAWINGS

FIG. 1 is a conceptual view showing a first embodiment of the present invention;

FIG. 2 is a perspective view showing a specific embodiment of FIG. 1;

FIG. 3 is a plan view of FIG. 2;

FIG. 4 is a rear view of FIG. 2;

FIG. 5 is a side view of FIG. 2; and

FIG. 6 is a conceptual view showing a second embodiment of the present invention.

### BEST MODE

Hereinafter, the configuration and operation of a first embodiment of the present invention will be described in detail.

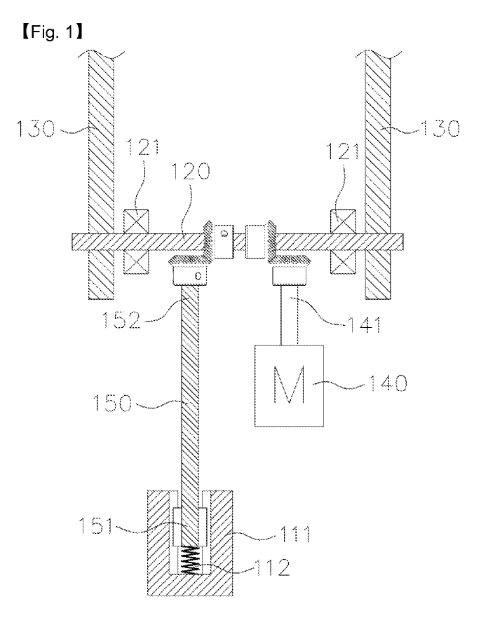

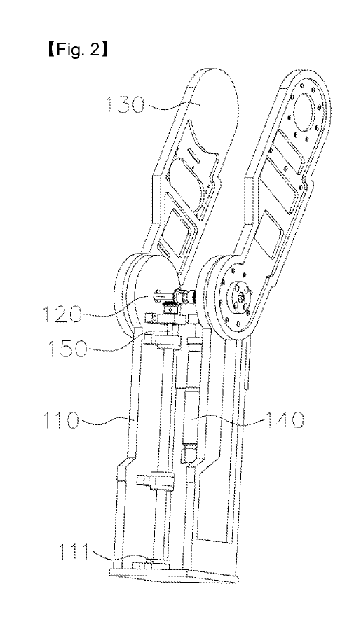

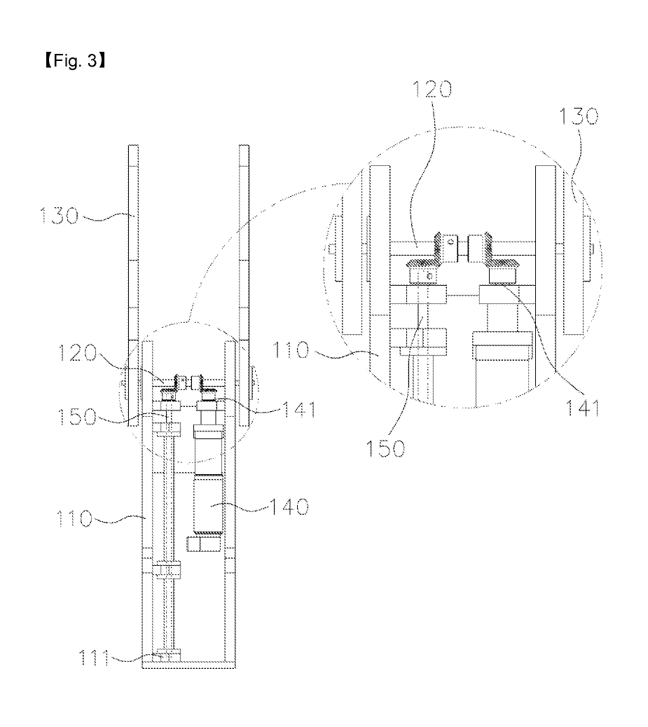

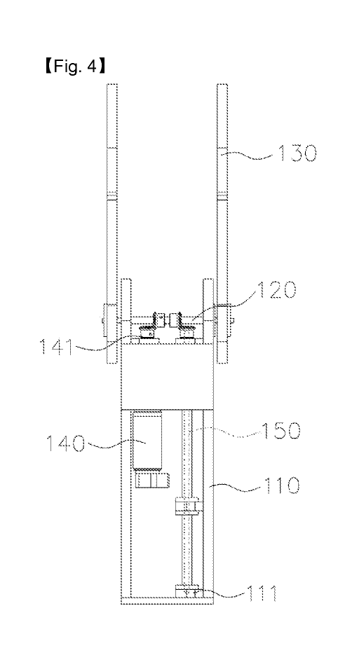

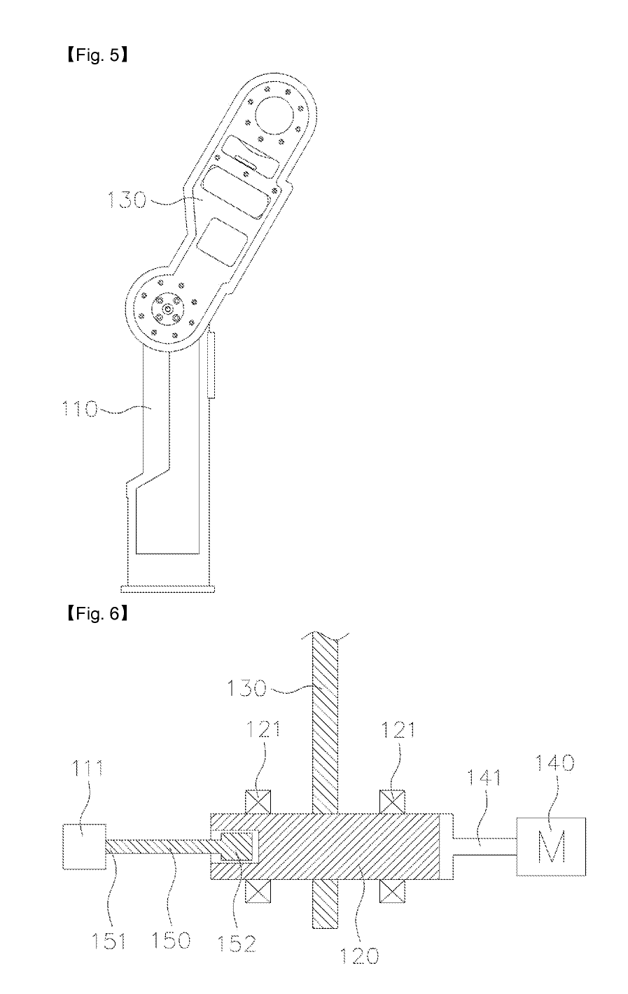

FIG. 1 is a conceptual view showing a first embodiment of the present invention, FIG. 2 is a perspective view showing a specific embodiment of FIG. 1, FIG. 3 is a plan view of FIG. 2, FIG. 4 is a rear view of FIG. 2, and FIG. 5 is a side view of FIG. 2.

First, the concept of this embodiment will be described with reference to FIG. 1.

According to this embodiment, all components except for a load 130 are provided on a supporting frame 110. For the sake of easy understanding, the supporting frame 110 is omitted in FIG. 1. However, it is considered that the function of the supporting frame 110 can be easily understood with reference to FIGS. 2 to 5.

In the case of a robot, the supporting frame 110 corresponds to a robot body or a robot joint. Further, in the case of devices using various kinds of driving motors, the supporting frame corresponds to all components supporting the load 130 via a rotating shaft 120.

The rotating shaft 120 is rotatably provided on the supporting frame 110 via a bearing 121.

The load 130, such as a robot arm, a leg of a walking robot, or an actuating arm, is secured to the rotating shaft 120. Thus, the load 130 can be rotated along with the rotating shaft 120.

In order to rotate the rotating shaft 120, a driving motor 140 is provided on the supporting frame 110.

The driving motor 140 may use various kinds of motors, including an electric motor or a hydraulic motor, as long as the motors provide a rotating force to the rotating shaft 120.

In this embodiment, a driving shaft 141 of the driving motor 140 is perpendicularly coupled to the rotating shaft 120 by bevel gear coupling. However, since this is only one embodiment, the driving motor 140 and the rotating shaft 120 may be coupled to each other by various other coupling methods.

The driving shaft 141 of the driving motor 140 may be an output shaft of the driving motor 140 or an output shaft of a reduction gear connected to the driving motor 140.

In such a configuration, when the driving motor 140 is driven, the rotating shaft 120 rotates, and the load 130 rotates about the rotating shaft 120 in conjunction with the rotating haft 120. At this time, load torque may vary depending on a rotating angle of the load 130. That is, the load torque changes depending on the gravity torque acting on the load.

In order to compensate for the gravity torque, the gravity compensator according to this embodiment is provided with a torsion bar 150, which serves as a spring by a torsion moment generated according to a rotating angle of the rotating shaft 120 to compensate for the gravity torque acting on the motor 140 due to the load when the rotating shaft 120 rotates.

According to this embodiment, the torsion bar 150 is placed to be perpendicular to the rotating shaft 120. That is, the torsion bar 150 and the driving shaft 141 of the driving motor 140 are oriented to be parallel to each other.

One end of the torsion bar 150 forms a rotary end 152 that is connected to the rotating shaft 120 to generate torsion, while the other end forms a fixed end 151 that is secured to the supporting frame.

To be more specific, the rotary end 152 is coupled to the rotating shaft 120 by bevel gear coupling. Thus, as the rotating shaft 120 rotates, the rotary end 152 is also rotated. The fixed end 151 is coupled to the supporting frame, so that it does not rotate along with the rotating shaft 120.

The torsion bar 150 is a steel bar that may accumulate energy when twisted. When the rotary end 152 is twisted by the rotation of the rotating shaft 120, the torsion bar accumulates energy using its own elasticity. When the torsion bar 150 is restored from the twisted state to its original state because of its own elasticity, the energy accumulated when the torsion bar is twisted is released to cope with the gravity torque acting on the motor 140.

According to an embodiment, the fixed end 151 may be fixedly coupled to the supporting frame to prevent a sliding movement as well as rotary movement.

However, as shown in FIG. 1, in the case where the gravity torque acting on the load 130 during the rotation of the rotating shaft 120 is considerably large, if the fixed end 151 does not rotate and the rotary end 152 rotates, the entire length of the torsion bar 150 may become shorter. In this case, unless the fixed end 151 slides, the entire length of the torsion bar 150 is reduced at the rotary end 152.

As such, if the fixed end 150 does not perform the sliding movement during the rotation of the rotary end 152, a reduction in length of the rotary end 152 due to the twisting of the rotary end 152 leads to a reduction in the overall length of the torsion bar 150, thus releasing the bevel coupling of the torsion bar 150 with the rotating shaft 120. Thereby, the gravity torque acting on the motor 140 during the rotation of the rotating shaft 120 is not transmitted to the torsion bar 150, thus making it impossible to compensate for the gravity torque.

In order to solve the problem, the gravity compensator of this embodiment is provided with a means for upwardly sliding the entire torsion bar 150 towards the rotating shaft 120 in proportion to the reduced length when the entire length of the torsion bar 150 is reduced due to the twisting of the rotary end 152.

To be more specific, the gravity compensator according to this embodiment has a fixed-end support part 111 on the supporting frame. Of course, it should be understood that the fixed-end support part 111 is a part of the supporting frame.

The fixed end 151 of the torsion bar 150 is coupled to the fixed-end support part 111 to prevent the fixed end from rotating. However, the fixed end 151 may slide along the fixed-end support part 111, namely, relative to the fixed-end support part 151 in a longitudinal direction of the torsion bar 150.

In place of such a configuration, the fixed end 151 of the torsion bar 150 may have the shape of a polygonal column, and the fixed-end support part 111 may have the shape of a polygonal recess. Further, the fixed end 151 and the fixed-end support part 111 may be configured to be coupled to each other by spline coupling. In addition to these configurations, various configurations permitting sliding while preventing rotation may be applied.

Moreover, the fixed-end support part 111 is provided with an elastic member 112 such as a spring. The elastic member 112 elastically supports the fixed end 151 in the longitudinal direction of the torsion bar 150.

Thus, if the fixed end 151 is not rotated but the rotary end 152 is rotated, so that the entire length of the torsion bar 150 is reduced, the reduction in length leads to movement of the fixed end 151 towards the rotary end 152. That is, since the elastic member 112 elastically supports the torsion bar 150 in the longitudinal direction thereof while the reduction in length of the torsion bar 150 is realized by the sliding of the fixed end 151 towards the rotary end 152, the rotary end 152 maintains bevel gear coupling with the rotating shaft 120.

In other words, if there is considerably large amount of a gravity torque acting on the load 130 during the rotation of the rotating shaft 120, so that the rotary end 152 is excessively twisted, the entire length of the torsion bar 150 may be reduced to release the bevel gear coupling between the torsion bar 150 and the rotating shaft 120. Even if the entire length is reduced as such, the entire torsion bar 150 moves up towards the rotating shaft 120 to make up for a reduction in length by elastic restoring force of the elastic member 112, because the torsion bar 150 is elastically biased upwards by the elastic member 112 making contact with the fixed end 151 in the fixed-end support part 111. Thereby, the torsion bar 150 can maintain the bevel gear coupling with the rotating shaft 120.

FIG. 2 is a perspective view showing the specific embodiment of FIG. 1, FIG. 3 is a plan view of FIG. 2, FIG. 4 is a rear view of FIG. 2, and FIG. 5 is a side view of FIG. 2.

FIGS. 2 to 5 show a specific embodiment of the gravity compensator. However, it can be easily understood that the entire operation and configuration including the supporting frame 110, the rotating shaft 120, the load 130, the driving motor 140, the driving shaft 141, the torsion bar 150, the fixed end 151, and the rotary end 152 remain the same as those of FIG. 1.

When the gravity compensator shown in the conceptual view of FIG. 1 is applied to an arm or leg of a robot as shown in FIGS. 2 to 5, the torsion bar 150 and the driving motor 140 may be placed in a direction in which a joint serving as the supporting frame is placed. Thus, such a configuration is very advantageous in that an additional space for receiving the torsion bar 150 is not required.

Further, since the torsion bar 150 generates the same torsion moment according to a rotating angle regardless of whether the rotating shaft 120 rotates forwards or backwards, it is possible to compensate for gravity in opposite directions. That is, this embodiment may compensate for gravity without using an additional device even if the rotating shaft 120 rotates in opposite directions.

Furthermore, since the torsion bar 150 may be designed to have a very stronger elastic force than a general coil spring, the gravity compensator equipped with such a torsion bar may be easily applied to a large-sized motor to compensate for gravity.

FIG. 6 is a conceptual view showing a second embodiment of the present invention.

The general configuration of the second embodiment remains the same as that of the first embodiment except for the following difference.

According to the second embodiment, a driving shaft 141 of a driving motor 140, a rotating shaft 120 and a torsion bar 150 are placed along the same axis.

Since the driving motor 140 and the rotating shaft 120 are directly connected to each other and the rotating shaft 120 and the torsion bar 150 are directly connected to each other, a bevel gear device is not required.

If the gravity compensator is designed such that a rotary end 152 of the torsion bar 150 rotates along with the rotating shaft 120 while sliding in an axial direction of the rotating shaft 120, the elastic member 112 of the first embodiment is not required. Further, a fixed end 151 may be secured to a fixed-end support part 111 so that its sliding movement is impossible.

That is, in the second embodiment, a reduction in entire length of the torsion bar 150 due to torsion can be compensated by the movement of the rotary end 152.

If a device has a sufficient volume, the gravity compensator designed as shown in FIG. 6 can achieve the object of the present invention.

In contrast, if an entire volume of a device is insufficient, the configuration of FIG. 6 is undesirable because it requires an increase in overall volume.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, the present invention provides a gravity compensator of a motor, intended to compensate for a gravity load caused by gravity torque depending on a rotating angle of a load, which acts on a rotating shaft rotating along with the load as a driving motor is driven.

1. A gravity compensator of a motor, comprising:
a supporting frame;
a rotating shaft rotatably provided on the supporting frame;
a load secured to the rotating shaft to be rotated along with the rotating shaft;
a driving motor supplying a rotating force to the rotating shaft to rotate the rotating shaft; and
a torsion bar connected at a first end thereof to the rotating shaft to form a rotary end that is rotated along with the rotating shaft, and connected at a second end thereof to the supporting frame to form a fixed end that cannot be rotated along with the rotating shaft.

2. The gravity compensator according to claim 1, wherein the fixed end of the torsion bar is coupled to the supporting frame in such a way as to slide in a longitudinal direction of the torsion bar.

3. The gravity compensator according to claim 2, further comprising:
an elastic member for elastically supporting the fixed end of the torsion bar in the longitudinal direction of the torsion bar.

4. The gravity compensator according to claim 1, wherein the torsion bar and a driving shaft of the motor are perpendicular to the rotating shaft, and the torsion bar is placed to be parallel to the driving shaft of the motor, and the rotary end of the torsion bar and the rotating shaft are coupled to each other by bevel gear coupling.
